(19) United States
(12) Patent Application Publication
(10) Pub. No.: US 2003/0096643 A1
(43) Pub. Date: May 22, 2003

(54) Data gathering for games of chance

(76) Inventor: Dennis L. Montgomery, Reno, NV (US)

Correspondence Address: PILLSBURY WINTHROP, LLP, P.O. BOX 10500, MCLEAN, VA, 22102, US

(21) Appl. No.: 09/991,531

(22) Filed: Nov. 21, 2001

(51) Int. Cl. G06F 17/00

(52) U.S. Cl. 463/11

(57) ABSTRACT

A method of monitoring a game of chance. The method includes operating a video camera to obtain a stream of data that includes a plurality of repetitive actions stored thereon relating to the game of chance, and automatically parsing the stream of data to count the plurality of repetitive actions, the count obtained providing an indicator usable to monitor the game of chance.

### 1. FIELD OF THE INVENTION

The present invention pertains generally to games of chance. More particularly, the present invention relates to methods and apparatus for gathering data on games of chance played in, for example, casinos.

### 2. BACKGROUND

Casinos are multi-billion dollar industries. Even though legalized gambling is a relatively young industry in this country, it continues to grow.

A necessary element for an effective casino operation is an efficient casino management and security system. Casinos spend substantial amounts of money to observe gamblers, dealers and others in the casino, using both electronic surveillance equipment and live personnel. Electronic surveillance usually takes the form of electronic camera globes or visible cameras (collectively cameras) which blanket the walls and ceilings of the casinos.

Another aspect of effective casino operation is using dealers who perform well. Dealers are schooled and trained in techniques which are supposed to be harmonized throughout the industry, focusing on the shuffle, card handling, and player association and relation. The interaction between the dealers and the gamblers is the scrutinized, since it is in that interaction that money passes from the dealer, and thus the casino, to the player.

The dealer/player interaction is, for the most part, monitored using electronic surveillance monitors that are viewed by individuals at a central location and by roving observers. While videocassette recording of from the cameras exists, it cannot be effectively used in assessing dealer's performance, or in otherwise monitoring games of chance.

Existing monitoring systems do not allow, therefore, casinos to know objectively how many games have been played by a certain point in time at a particular gaming table. Thus, monitoring of gaming tables has required human monitoring, which is not only prone to mistakes, but adds another degree of uncertainty, since the human monitor can be influenced.

It would be advantageous, therefore, to be able to monitor certain activities that relate to games of chance played at gaming tables automatically, without requiring human intervention. For example, automatically monitoring the number of games or hands played at a particular table during the shift of a particular dealer, with the results obtained being a useful indicator of the effectiveness of the dealer, of the players, and, ultimately, of the casino operation as a whole.

### 3. SUMMARY

A method of automatically monitoring a game of chance is described. The method includes operating a video camera to obtain a stream of data that includes a plurality of repetitive actions stored thereon relating to the game of chance, and automatically parsing the stream of data to count the plurality of repetitive actions, the count obtained providing an indicator usable to monitor the game of chance.

### 4. BRIEF DESCRIPTION OF THE DRAWINGS

The present invention is illustrated by way of example, and not limitation, in the figures of the accompanying drawings in which like references denote similar elements, and in which:

FIG. 1 illustrates a gaming table according to one embodiment of the present invention;

FIG. 2 illustrates a player place setting having a bet area and a play area;

FIG. 3 illustrates a sequence of repetitive actions that are possible in game played in accordance with an embodiment of the present invention;

FIG. 4 illustrates a mask for a player place setting in which no cards and bets are present and a mask for a dealer setting in which no cards are present;

FIG. 5a illustrates a roulette layout and mask for usage with the roulette layout;

FIG. 5b illustrates a roulette wheel and mask for usage with the roulette wheel;

FIG. 6 illustrates a sequence of repetitive actions for a roulette wheel and ball;

FIGS. 7A-7B illustrate exemplary reports generated from repetitive actions being monitored

### 5. DETAILED DESCRIPTION OF THE PREFERRED EMBODIMENTS

Techniques for gathering data about a game of chance are described. In the following description, for purposes of explanation, numerous specific details are set forth in order to provide a thorough understanding of the present invention. It will be evident, however, to one skilled in the art that the present invention may be practiced in a variety of games, especially card games, without these specific details. In other instances, well-known operations, steps, functions and elements are not shown in order to avoid obscuring the invention.

Parts of the description will be presented using terminology commonly employed by those skilled in the art to convey the substance of their work to others skilled in the art, such as parsing, pattern recognition, dealer, bet, game of chance, and so forth. Various operations will be described as multiple discrete steps performed in turn in a manner that is most helpful in understanding the present invention. However, the order of description should not be construed as to imply that these operations are necessarily performed in the order that they are presented, or even order dependent. Lastly, repeated usage of the phrases “in one embodiment,” “an alternative embodiment,” or an “alternate embodiment” does not necessarily refer to the same embodiment, although it may.

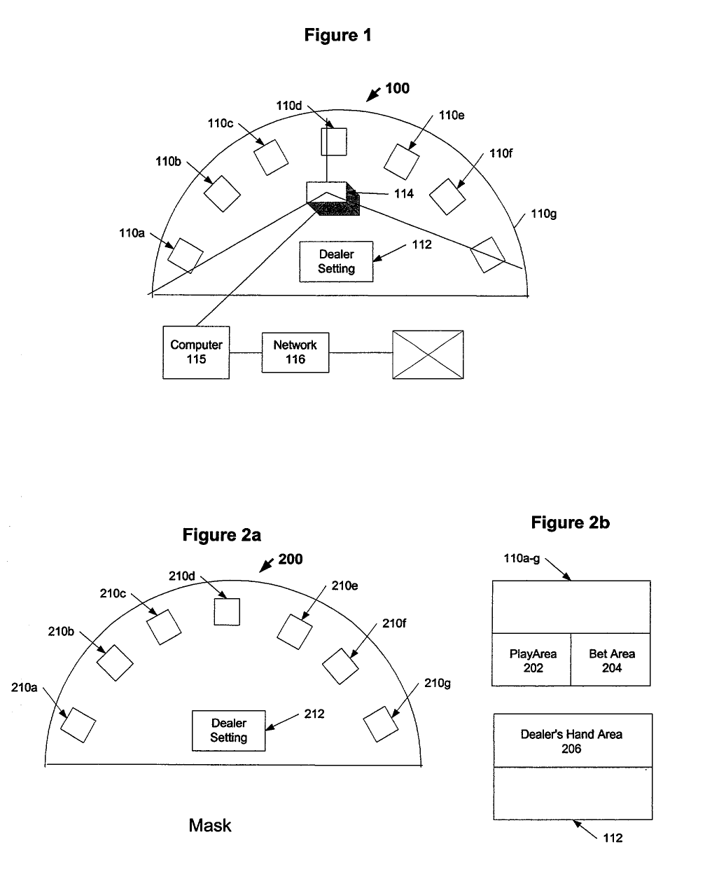

FIG. 1 illustrates data gathering system according to one embodiment of the present invention. System 100 includes player place settings 110a-g, dealer setting 112, camera 114, computer 115, network 116 and terminal 117. Camera 114 films table 100 and player place settings 110a-g and dealer setting 112 to obtain a stream of digital data that includes the repetitive actions that occur. The repetitive actions are activities that occur in the place settings 110a-g and dealer setting 112. The camera 114 is preferably fixed, and is preferably set at a same zoom position for all comparison operations performed as described herein, so that as much consistency between adjacent frames in the stream of digital data as possible are obtained.

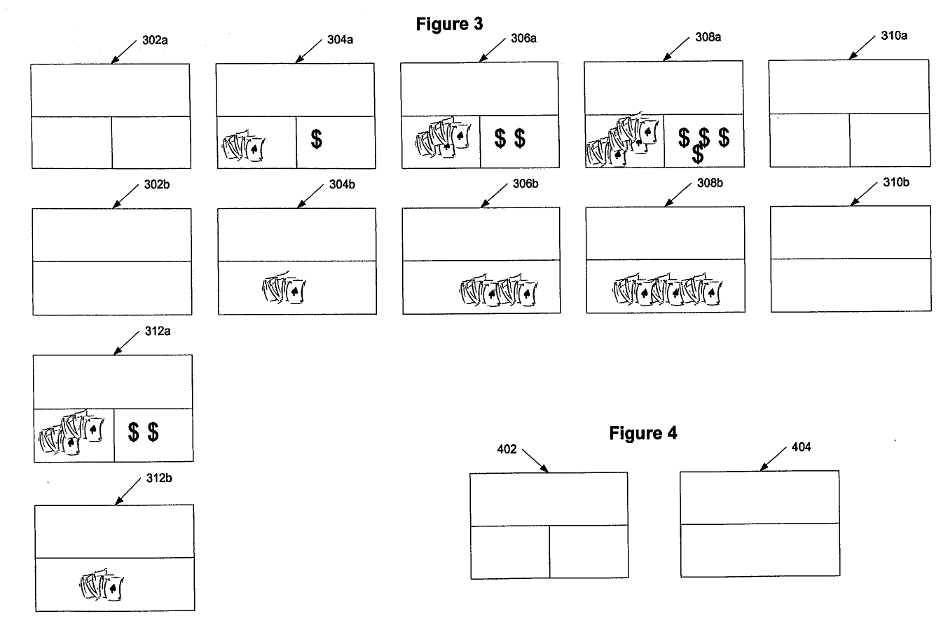

As shown in FIG. 2b, a player place setting 110a-g has bet area 202 and play area 204. During a card game such as blackjack, for example, a player will place bets such as chips or jetons in bet area 202 and cards of the player's hand in play area 204. As the card game develops, and a card is added to the hand or the hand is split, activity takes place in play area 204 and possibly in bet area 202. Similarly, the dealer's hand will be placed in dealer's hand area 206. As the card game develops, a card or cards may be added to dealer's hand area 206. FIG. 3 illustrates a sequence of repetitive actions that are possible in a game played in accordance with an embodiment of the present invention. At 302a each of player's place setting 110a-g are clear of any cards and bets, and at 302b the dealer's setting 112 are clear of any cards. As the card game develops from 302a to 312a and from 302b to 312b cards are added to play area 204 and to dealer's hand area 206 and bets are placed on bet area 202. The sequence of repetitive actions 302a-312a are representative of what happens at one of the player place settings 110a-g. A sequence similar to that shown in FIG. 3 can occur for other player place settings.

By taking the stream of data that emerges from the camera and parsing it at computer 115 to determine the transitions that occur, the number of hands that are being played at a table can be determined. This is possible according to one embodiment of the present invention by using a mask, described further hereinafter, to detect transitions between hands (i.e., the end of a hand or the beginning of a new hand). According to one embodiment, the mask is indicative of a place setting in which no cards and bets are present. However, other indications of the beginning of a hand or the end of a hand can be used. FIG. 2a illustrates a mask for a gaming table according to one embodiment of the present invention. Mask 200 includes masks for player place settings 210a-g and mask for dealer place setting 212.

Computer 115 stores mask 200 and uses it to detect transitions between hands. FIG. 4 illustrates the masks for player place settings and the dealer place setting in greater detail. Mask 402 is for player place setting 210a-g in which no cards and bets are present, and a mask 404 is for a dealer setting 212 in which no cards are present. By comparing at computer 115 each of the repetitive actions to the corresponding mask it can be determined whether a hand has ended and/or a new hand is about to begin. In between hands, the continuous frames that will illustrate the mask are not each counted as a separate hand.

For example, by comparing mask 402 to 302a it is clear that a hand is about to begin. If the progress of the game is followed and the stream of data from the camera is parsed and the mask is compared to subsequent frames, it is not until 310a that mask 402 and 310a are identical, indicating that a hand has been completed. At that point, a counter that keeps track of hands being played at table 100 can be incremented. The process of comparison continues with repetitive actions 312a and 312b.

Technically, the above-described pattern comparisons require pattern matching operations to be performed between the mask 402 and that portion of the digital data stream corresponding to the location of the mask 402 during the playing of the game of chance. The mask 402, in such comparison operations, is essentially an external pattern that is being searched for in a particular location of each frame of the stream of digital data representing the image. Conventional pattern recognition systems can be used to operate upon the stream of digital data and obtain the indications of the mask 402 being within the stream of digital data that is obtained. Further, the mask area can be fuirther required to at least have recognized within it an object of significance to it, such as a card or a chip, in order to prevent an errant object, such as a hand, that appears in the mask area from incorrectly indicating that a game is underway or has been completed.

And while a mask as described is a preferred manner of comparison for pattern recognition purposes, it is not the only manner in which the comparisons can be made. Comparisons between frames can also be made, such that continued durations of an activity can generate a count. For instance, white space on a dealer card area that exists for greater than a predetermined period of time could be used to generate a count, with another count not being generated until after that dealer card area has had cards placed thereon for another predetermined period of time.

The above description was made in the context of one player playing with a dealer. It should be appreciated that more than one player can be playing at one time with the dealer. In the event of multiple players are playing at a table and a player's hand finishes before that of other players, the player's hand which finishes is detected when the player clears the player's bet area and play area. Each time it is detected that a player's hand has ended, a hand counter (a software register, not shown) can be incremented at computer 115. The information about hands played at a gaming table and other information that can be gathered based on the present invention is provided via network 116 to terminal 117 or other terminals (not shown). Network 116 can be the Internet, another distributed internet network, or a dedicated network.

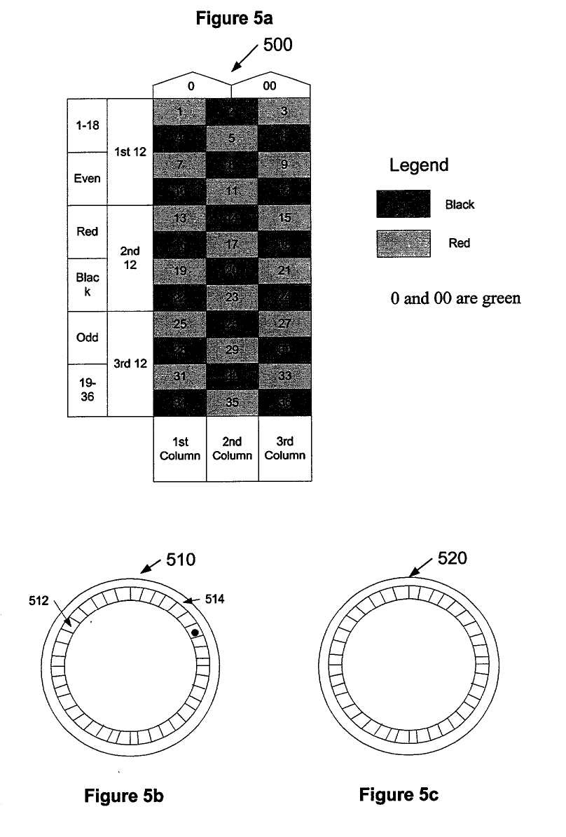

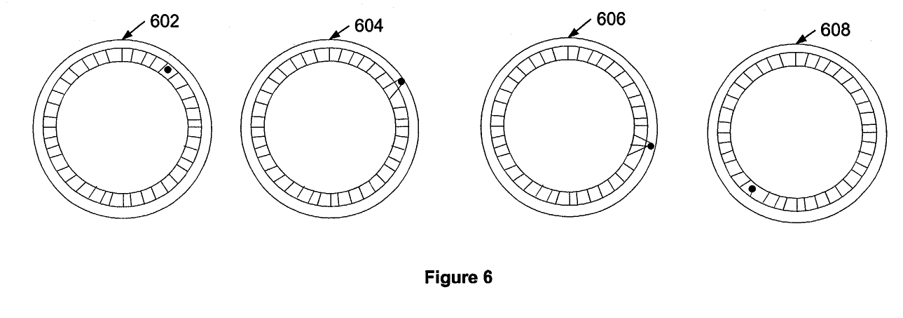

FIG. 5a illustrates a roulette layout. Layout 500 is divided into 50 areas for placing bets. The fundamental area of layout 500 is the alternating area of red and black numbers 1-36 and digits 0 and 00 that are colored green. The remaining areas are permutations of the fundamental area: areas for even numbers, odd numbers, red numbers, black numbers, first 12 numbers, second 12 numbers, third 12 numbers, first 18 numbers, and last 18 numbers. One can bet on any single number (straight up), a combination of numbers, red, black, odd or even. Each of the one to six players at the roulette table is given different-colored chips so that keeping track of the numbers on the layout one is betting on is possible using a reference to the color.

FIG. 5b illustrates a roulette wheel. Wheel 510 is divided into 38 slots 512 for a ball to land in, and is numbered 1 through 36, 0 and 00. Each roulette game begins when the dealer spins the wheel in one direction, and then rolls a small ball along the inner edge 514 of wheel 510 in the opposite direction. The ball eventually falls into one of the numbered slots 512. That number is the declared winner for that game.

FIG. 5c illustrates a mask 520 for a roulette wheel, which can be as simple as tracking the slot area 512 that the ball rolls into. Mask 520 is stored in a computer such as computer 115 of FIG. 1 and is used to detect the transitions between roulette games. During a single game, the ball is rolled, the wheel is spun, and then the ball lands in one of the slots 512. A camera such as camera 114 is placed to view the wheel 510 and is used to capture the repetitive actions of the roulette wheel and ball. In particular, each time the ball rolls into a slot, this indicates that the game is complete, and can be recorded as a repetitive sequence. That camera, or another camera, can also be used to capture the repetitive action of chips being played on the table, with each of the separate betting areas having its own mask area, which can be queried for repetitive activity using the techniques described above. Similarly, the actions of chips being taken away from losing bets by the dealer, and other chips being provided to the winner from the dealer, are repetitive activities that can be used to count the number of games that take place in a given period of time.

FIG. 6 illustrates a sequence of repetitive actions for a roulette wheel and ball. By comparing at a computer, such as computer 115, mask 520 to the repetitive actions 602-608 it can be determined that 2 games have been played. This is known in the sequence of four frames (with other frames in between not shown), since when the ball comes to rest on any slot 512 can be used as an indication that a game has been completed, which action is shown by actions 602 and 608. Alternatively, each time the ball appears in the inner edge 514 of wheel 510 can be used to indicate that a new game is occurring. By keeping track ofthe time, the efficiency of the roulette dealer can be tracked. Further, by tracking both the mask 520 and the mask associated with each separate betting area, it can be determined that the declared winner at the table corresponds to the actual winner as determined by which numbered slot 512 the ball actually fell into.

The present invention can be adapted for other repetitive games, such as poker, 3-card poker, pai-gow, Caribbean stud, baccarat, and other games.

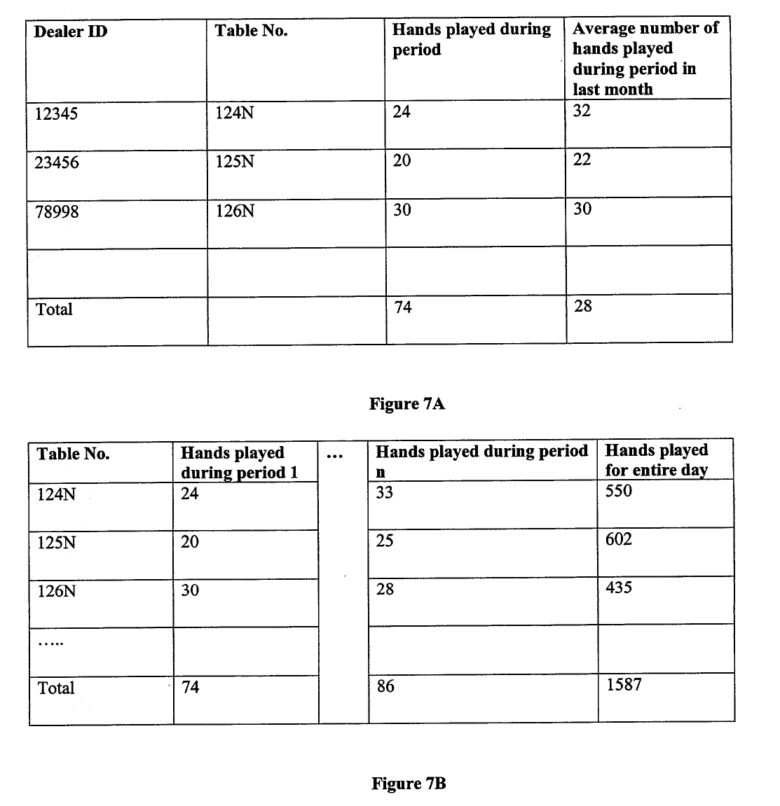

Further, reports can be generated based upon the statistics obtained by the present invention. By keeping track of the particular dealer at each table for a predetermined period, the number of hands dealt in the period can be obtained. And by combining periods for a particular dealer, that dealer's average efficiency can be determined. Further, statistics can be kept for a table location basis, for example, so that it can be determined which tables are busiest during various periods of time, which can then allow, again for example, staffing of the busiest tables with the most efficient dealers. FIGS. 7A and 7B illustrate two different reports, directed to a dealer and a table location, respectively, illustrating the statistics obtained over a single shift of a predetermined duration. Added security also is obtained, since verification that payouts were made to actual winners can occur.

Other repetitive activities can also be monitored using the techniques of the present invention.

For example, in casinos, money is always counted in the same manner, with money being laid out on a table in exactly the same manner, typically in increments of $20,000 in the United States. Each action can be tracked if desired, such that at each position where the next amount of money is laid, that is tracked, and then it is tracked that at the next expected position money is then laid out there. If there is a deviation from this, which can also be time based, an alert can be triggered.

As another example, cameras in hallways can be used to keep track of the period of time that a laundry cart is in front of a specific room, using a mask that contains a picture of the room without a cart in front. When an object appears for a period of time greater than 3 minutes, for example, the object can be interpreted to be the cart. The period of time until that object is removed from the scene can be used to monitor the amount of time the cart was in front of the room, and therefore obtain an estimate of the time that was needed to clean the room.

In still another example, the repetitive action of making money payouts by a dealer can be used to count the amount of money paid out. Since typically a camera is above a table, a perspective view of the rack that contains the chips that are used for payouts cannot be obtained. Since, however, it is typical to place a silver coin between every five chips, Each time a silver coin seen in an area corresponding to a particular column of chips being paid out appears can be used to estimate that five chips times the value of those chips has been paid out. Thus, counting the instances of recognizing that silver coin in an area corresponding to that column of chips allows a total estimate of an amount paid out to be obtained. Thus, the repetitive action is looking for the instances that silver appears in a mask area corresponding to that column of chips.

Of course, other repetitive activities can also be monitored automatically using the techniques described herein.

Thus, methods and apparatus for data gathering for games of chance, as well as other repetitive actions, have been described. Although the present invention has been described with reference to specific exemplary embodiments, it will be evident to one of ordinary skill in the art that various modifications and changes may be made to these embodiments without departing from the broader spirit and scope of the invention as set forth in the claims. Accordingly, the specification and drawings are to be regarded in an illustrative rather than a restrictive sense.

We claim:

1. A method of monitoring a game of chance that contains a repetitive action, the method comprising:
obtaining a stream of digital image data that includes a plurality of the repetitive actions stored thereon relating to the game of chance; and
automatically parsing the stream of digital image data to count the plurality of repetitive actions, the count obtained providing an indicator usable to monitor the game of chance.

2. The method of claim 1, wherein the step of automatically parsing the stream performs pattern recognition on fixed locations.

3. The method of claim 1, wherein the step of obtaining the stream of digital image data uses a video camera fixed in position that does not zoom.

4. The method of claim 1, wherein the repetitive action includes an action of a dealer.

5. The method of claim 4, wherein the repetitive action of the dealer corresponds to an area of the table where the dealer deals.

6. The method of claim 1, wherein the repetitive action includes an action of a player.

7. The method of claim 6, wherein the repetitive action of the player corresponds to an area of the table where the player bets.

8. The method of claim 6, wherein the repetitive action of the player corresponds to an area of the table where the player plays.

9. The method of claim 1, wherein the repetitive action includes actions of both a dealer and a player.

10. The method of claim 1, wherein the repetitive action includes an action of an object.

11. The method of claim 10, wherein the repetitive action of the object a landing of a marble in a slot of a wheel in a game of roulette.

12. The method of claim 11 further including the step of comparing a slot where the marble lands with a placement of a marker on a table position.

13. The method of claim 12 further including the step of triggering an event alarm if the slot where the marble landed and the table position where the marker was placed do not correspond to each other.

14. The method of claim 10 the repetitive action of the object is the marble being located at an inner edge portion of a wheel in a game of roulette.

15. The method of claim 1, wherein the game of chance is a card game.

16. The method of claim 15, wherein the repetitive action is an absence of cards at a predetermined location of a table.

17. The method of claim 15, wherein the repetitive action is an existence of objects at a predetermined location of a table.

18. The method of claim 15, wherein the card game is one of blackjack, pai-gow, 3 card poker, and baccarat.

20. The method of claim 15, further including the step of comparing a color of a card against a color of a deck being dealt to assist in ensuring that the card is a legitimate card.

21. The method of claim 1, wherein the step of automatically parsing uses a mask to compare a scene corresponding to a location on a frame with the mask.

22. The method of claim 20, wherein the scene corresponds to an area of a table where cards are placed.

23. The method of claim 20, wherein the scene corresponds to an area of a table where bets are placed.

24. A method of monitoring a repetitive action, the method comprising:
obtaining a stream of digital image data that includes a plurality of the repetitive actions stored thereon; and
automatically parsing the stream of digital image data to count the plurality of repetitive actions, the count obtained providing an indicator usable to monitor the repetitive action.

25. The method of claim 1, wherein the step of automatically parsing the stream performs pattern recognition on fixed locations of frames.

26. The method of claim 23 wherein the stream of digital image data includes a plurality of frames, and a portion of each frame is compared to a mask.

27. The method of claim 23 wherein adjacent frames that both contain the portion that corresponds to the mask do not indicate a repetitive action.

28. A method of counting a plurality of objects comprising:
obtaining a stream of digital image data that includes therein a repetitive sequence that exists with respect to the plurality of objects; and
automatically parsing the stream of digital image data to count the repetitive sequence that exists; and
using the counted repetitive sequence that exists to estimate a number of the plurality of objects.

29. The method of claim 27, wherein the plurality of objects include a plurality of vertically stacked chips separated by a spacer at repetitive intervals and the step of automatically parsing counts each different spacer.

30. The method of claim 27 wherein the plurality of objects include a plurality of object locations, wherein a predetermined value amount is placed at each object location, and wherein the step of automatically parsing counts each placement of another predetermined value amount at another sequential object location.

31. The method of claim 30 fuirther including the step of triggering an event alarm if the step of automatically parsing detects placement of a value amount at a location that does not correspond to the next sequential object location.
